(19) United States
(12) Patent Application Publication
(10) Pub. No.: US 2004/0153484 A1
(43) Pub. Date: Aug. 5, 2004

(54) Fixed-point filter and method

(76) Inventor: Takahiro Unno, Richardson, TX (US)

Correspondence Address: TEXAS INSTRUMENTS INCORPORATED, P O BOX 655474, M/S 3999, DALLAS, TX, 75265

(21) Appl. No.: 10/355,990

(22) Filed: Jan. 31, 2003

(51) Int. Cl. G06F 1/00

(52) U.S. Cl. 708/131

(57) ABSTRACT

Fixed-point representation of impulse response coefficients by partitioning the sequence of coefficients into bins according to sequence index intervals, and within each bin quantizing to the fixed-point format providing the greatest resolution without overflow; then computing the total fixed-point quantization error; lastly, optimizing the partitioning to minimize the total fixed-point quantization error and thereby define the fixed-point representation.

### BACKGROUND OF THE INVENTION

The present invention relates to electronic devices, and more particularly to digital filtering with fixed-point processors and related devices.

Digital signal processing has a wide variety of applications from seismic analysis to EEG/EKG interpretation to video and speech compression, transmission, and decoding. For example, digital filtering can remove unwanted frequency bands and compensate for transmission channel distortions. Consumer devices typically require low-cost components, such as digital signal processors (DSPs), which commonly use fixed-point arithmetic. The length of fixed-point representation in bits determines the dynamic range of values. Each fixed-point value must be chosen to accommodate the largest values without overflow and the smallest values with sufficient precision. For time-invariant filters, the fixed-point representation of filter coefficients can be previously determined by taking overflow and precision into account. Conventionally, they are represented in 16 bits with a single binary point format. In fact, this conventional fixed-point representation has been widely used for efficient implementation while sacrificing the filter performance such as stop-band attenuation to some extent. However, the performance degradation may not be acceptable for the applications that strictly require high performance of filters.

### SUMMARY OF THE INVENTION

The present invention provides enhanced fixed-point format for a set of numbers, such as digital filter coefficients, by partition of the numbers into bins with numbers in a bin having their binary point dependent only upon the bin.

This had advantages including improved digital filter performance from a very small increase in computational overhead.

### BRIEF DESCRIPTION OF THE DRAWINGS

The drawings are heuristic for clarity.

FIG. 1 is a flow diagram for a preferred embodiment method.

FIGS. 2a-2c show fixed-point quantization error.

FIGS. 3a-3b illustrate the preferred embodiment methods.

### DESCRIPTION OF THE PREFERRED EMBODIMENTS

### 1. Overview

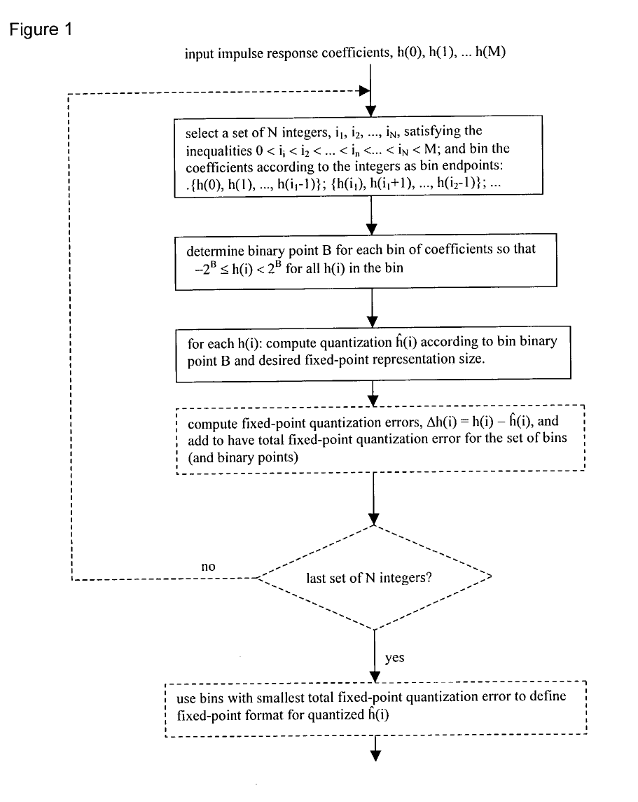

Preferred embodiment methods of fixed-point digital filter coefficient representation partition the filter coefficients into bins as indicated by the broken lines for the filter impulse response illustrated in FIG. 1; each bin has its own particular fixed-point resolution. Further preferred embodiments adjust the partition to optimize overall filter performance. Preferred embodiment filters incorporate preferred embodiment methods, either as programs on programmable processors or as hardwired circuitry or as a mixture of such.

Preferred embodiment filter systems could include one or more digital signal processors (DSPs) and/or other programmable devices with stored programs and/or special-purpose accelerators for performance of the preferred embodiment fixed-point filtering methods. The systems may also contain analog integrated circuits for amplification of inputs to or outputs from antennas and conversion between analog and digital formats; and these analog and processor circuits may be integrated on a single die. The stored programs may, for example, be in ROM onboard the processor or in external flash EEPROM. The DSP core could be a TMS320C6xxx or TMS320C5xxx from Texas Instruments.

### 2. First Preferred Embodiment

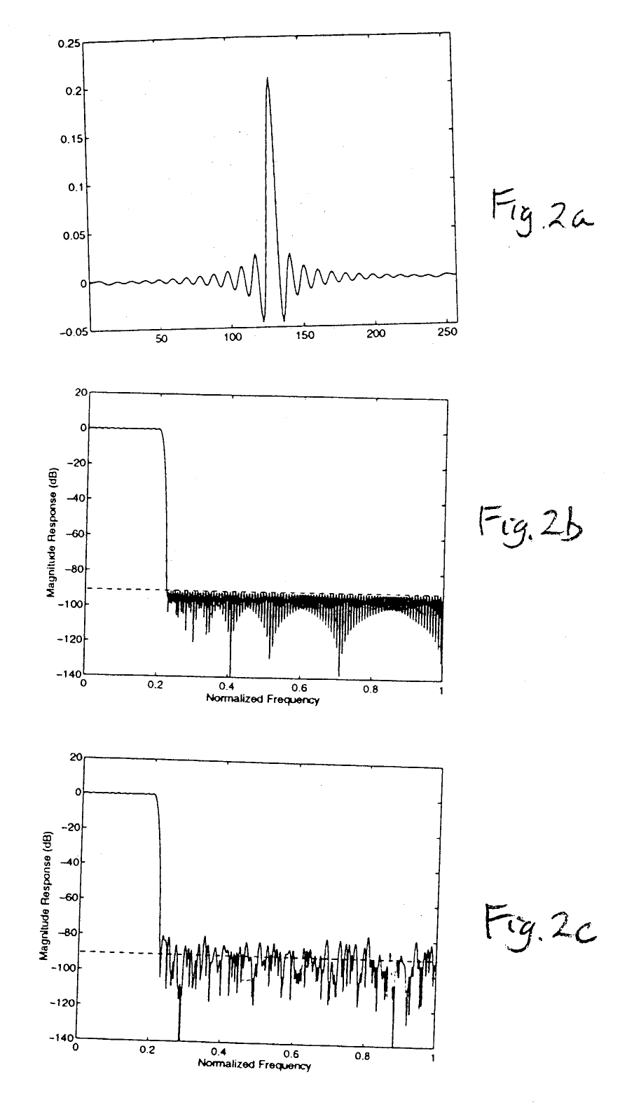

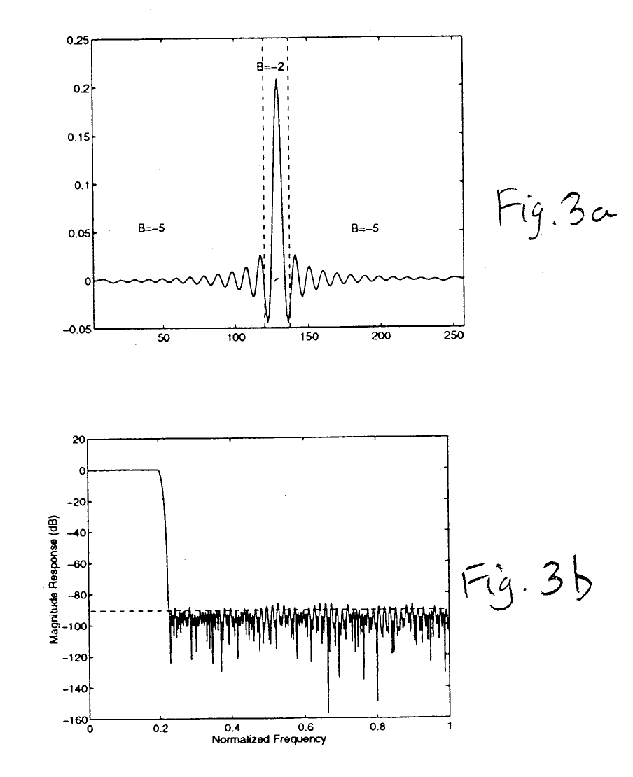

To describe the first preferred embodiment fixed-point representation methods, initially consider the FIR digital filter impulse response h(i) illustrated in FIG. 2a [disclosure FIG. 3] (illustrated as a continuous curve for easy visualization). The impulse response has coefficients h(0), h(1), . . . , h(255), h(256) with the maximum coefficient magnitude equal to 0.210 . . . at h(128). The coefficients h(i) may be given in floating point or greater-than-16-bit fixed-point format, and FIG. 2b [disclosure FIG. 1] shows the impulse response discrete Fourier transform H(e^{iω}) with the frequency variable normalized. As FIG. 2b indicates, h(i) is a lowpass filter with 90 dB attenuation in the stop band.

The conventional representation of the h(i) in a 16-bit fixed-point format is straightforward: the maximum floating-point coefficient is h(128)=0.210 . . . which in binary is 0.001101 . . . , so the fixed-point bits are allocated to a sign bit and magnitude bits with the most significant magnitude bit representing binary 0.001 (=2⁻³). The other h(i) are quantized (rounded off) to fit into this 16-bit format. That is, h(128) is fixed-point 01101 . . . where the leading 0 bit indicates a positive number and 1101 . . . are magnitude bits with the MSB representing 0.001. Constraining the binary representation to 16 bits requires quantizing (rounding off) h(128) to the nearest binary 0.000 0000 0000 0000 01 (=binary 0.001 * 2⁻¹⁴), this yields ĥ(128) which is expressed exactly in 16-bit fixed-point format. The other coefficients h(i) are then also quantized to the same precision (binary 0.001 * 2⁻¹⁴) to yield the ĥ(i) which all have the same binary point and are represented in the same 16-bit fixed-point format; that is, the MSB of the magnitude bits aligns to binary 0.001.

The location of the binary point to set the 16-bit fixed-point format can be determined generally as follows. First, define integer B so that −2^{B} ≦h(i)<2^{B} for all h(i) floating-point coefficients; note that the two inequalities differ because for twos complement format the most positive expression is 0111 . . . 1111 which equals 2¹⁵−1, whereas the most negative expression is 1000 . . . 0000 which equals −2¹⁵. Thus the MSB of the magnitude bits corresponds to 2^{B-1} and should be aligned to the MSB of the maximum magnitude |h(i)| in binary. For example, B=−2 for ĥ(128)=0.001101 . . .

The fixed-point quantization error Δh(i)=h(i)−ĥ(i) has the following bounds for 16-bit format because the maximum error equals the round off bit value which is 15 bits from the MSB

−2^{B-16}<Δh(i)≦2^{B-16}

This provides a simple upper bound on the discrete Fourier transform of the fixed-point quantization error:

$$\begin{matrix}\vert Δ H ( {ⅇ}^{j ω} ) \vert = \vert {\sum }_{0 \leq n \leq 256} Δ h ( n ) {ⅇ}^{- j ω n} \vert \\ \leq {\sum }_{0 \leq n \leq 256} \vert Δ h ( n ) \vert \vert {ⅇ}^{- j ω n} \vert \\ \leq ( 257 ) {2}^{B - 16}\end{matrix}$$

The bound increases for increasing filter length (more than 257 coefficients), increases as the binary point shifts to the right (B increases), and decreases and the number of bits in the fixed-point format increases (more than 16).

FIG. 2c [disclosure FIG. 2] shows the transform Ĥ(e^{iω}) of the quantized impulse response and illustrates the fixed-point quantization error appearing in the stop band: compare FIG. 2c to FIG. 2b.

The first preferred embodiment methods generally adjust the binary point for converting floating-point (or higher precision fixed-point) impulse response coefficients to a fixed-point format according to an optimization of the fixed-point quantization error. In particular, FIGS. 3a-3b [disclosure FIGS. 4-5] illustrate the results of the first preferred embodiment method which proceeds as follows.

(1) Select a pair of integers, i₁ and i₂, in the range 0<i₁<i₂<256.

(2) Partition the set of floating-point coefficients h(0), h(1), . . . , h(256) into three bins: h(0), h(1), . . . , h(i₁−1) in the first bin, h(i₁), h(i₁+1), . . . , h(i₂−1) in the second bin, and h(i₂), h(i₂+1), . . . , h(256) in the third bin.

(3) For each bin find the binary point B which is the smallest integer B such that −2^{B}≦h(i)<2^{B} for all floating-point coefficients h(i) in the bin. For example, if i₁ is less than 128 and i₂ is larger than 128, then the second bin will contain h(128) and, as previously noted, B will be −2. And further, if the maximum h(i) for h(i) in the first bin is h(iₘₐₓ)=0.015 (=0.00000011 . . . binary), then the B for the first bin would be −6.

(4) For each floating-point coefficient h(i), compute the corresponding quantized coefficient ĥ(i) using the binary point B found in step (3) for the bin containing h(i); that is, convert h(i) to binary fixed-point format and then round off at the B−15 bit. Thus ĥ(i) has a 16-bit fixed-point representation (bits 0:15) where the magnitude MSB (bit 1) corresponds to 2^{B-1}. (For the special case of h(i)<2^{B} but quantization round off yields ĥ(i)=2^{B}, apply saturation in the 16-bit fixed-point representation.) Also compute the fixed-point quantization error Δh(i)=h(i)−ĥ(i). For example, the 16-bit fixed-point representation of quantized ĥ(iₘₐₓ) for the floating-point h(iₘₐₓ) from step (3) will be expressed as 011 . . . with the leading 0 indicating the positive sign of h(iₘₐₓ) and the magnitude bits 11 . . . representing 0.00000011 . . . and reflecting B=−6. For a negative h(iₘₐₓ) the representation would be the twos complement of 011 . . .

(5) Compute a total fixed-point quantization error for the set of bins and binary points; this could be the sum of absolute values, Σ_{0≦n≦256}|Δh(n)|, or the sum of squares, Σ_{0≦n≦256}|Δh(n)|², or some other measure of size, where the Δh(n) were computed in step (4).

(6) Repeat steps (2)-(5) for other pairs of integers i₁ and i₂.

(7) Compare the results of the steps (5) for the pairs of integers. Select the pair of integers which minimizes the total fixed-point quantization error, and use the fixed-point representations from the corresponding step (4) for the fixed-point impulse response coefficients. Thus, when filtering with the fixed-point impulse response, a multiplication partial product is shifted B bits according to the B of the bin containing the coefficient. Of course, multiply and accumulation in order from smaller coefficients to larger coefficients provides greater accuracy. Hence, start the multiply and accumulate with coefficients from the bin with the smallest (most negative) B, and progress through bins with larger Bs.

FIG. 3a shows the bins resulting from the first preferred embodiment method with the sum of squares used as the measure of fixed-point quantization error in step (5). The integer pair minimizing the fixed-point quantization error were i₁=119 and i₂=138; the maximal coefficient, ĥ(128), ended up in the second bin which thus had B=−2, and the first and third bins had B=−5. FIG. 3b shows the transform and comparison to FIG. 2c illustrates the smaller stop band appearance of fixed-point quantization error. This binning reduced the total fixed-point quantization error by a factor of 10 dB.

### 3. Preferred Embodiments With Bin Searching

FIG. 1 (including broken-line blocks) is a flow diagram for preferred embodiment methods of finding fixed-point representations of floating-point (or higher-precision fixed-point) impulse response coefficients h(i) for either FIR or IIR filters with 0≦.i≦M (M is the length of the filter). The methods include the following steps.

(1) Select the number of binary point formats (bins), N+1, to be used.

(2) For a set of N integers, i₁, i₂, . . . , i_{N}, satisfying the inequalities 0<iᵢ<i₂<. . . <iₙ<. . . <i_{N}<M, partition the set of coefficients h(0), h(1), . . . , h(M) into N+1 bins: h(0), h(1), . . . , h(i₁) in the 0th bin; h(i₁), h(i₁+1), . . . , h(i₂−1) in the 1st bin; . . . ; h(iₙ), h(iₙ+1), . . . , h(iₙ₊₁−1) in the nth bin; . . . ; and h(i_{N}), h(i_{N}+1), . . . , h(M) in the Nth bin.

(3) For each bin find the binary point B, which is the smallest integer B such that −2^{B}≦h(i)<2^{B} for all coefficients h(i) in the bin.

(4) For each coefficient h(i), compute the corresponding quantized fixed-point coefficient ĥ(i) by rounding off to precision 2^{B-L+1} where B is the binary point found in step (3) for the bin containing h(i) and where L is the length of the target fixed-point representation (number of bits including the sign bit). Thus ĥ(i) can be represented exactly as an L-bit fixed-point number with the MSB magnitude bit of value 2^{B-1}.

(5) For each coefficient h(i), compute the fixed-point quantization error Δh(i)=h(i)−ĥ(i). (Thus this error satisfies −2^{B-L}<Δh(i)≦2^{B-L}.)

(6) Compute a total fixed-point quantization error. This total error could be any convenient measure of the set of Δh(i), such as the sum of absolute values, Σ_{0≦i≦M}|Δh(i)|, or the sum of squares, Σ_{0≦i≦M}|Δh(i)|², where the Δh(i) were computed in step (5).

(7) Repeat steps (2)-(6) for other sets of integers i₁, i₂, . . . , i_{N}.

(8) Compare the total fixed-point quantization errors of the steps (6) for the sets of integers i₁, i₂, . . . , i_{N}. Select the set of integers which minimizes the total fixed-point quantization error, and use the corresponding fixed-point representation from the step (4) for the fixed-point impulse response coefficients (together with the binary points B for the bins).

Note that for a symmetric impulse response, such as with a linear phase FIR filter, only one half of the coefficients need to be evaluated, and the binary point bins are symmetrically situated. For example, the impulse response of FIG. 3a [disclosure FIG. 4] illustrates the symmetry.

### 4. Non-searching Preferred Embodiments

FIG. 1 (excluding the broken-line blocks) illustrates further preferred embodiment methods which modify the methods of foregoing section 3 by skipping the searching over sets of N integers (steps (5)-(8)). That is, pick a set of N integers, i₁, i₂, . . . , i_{N}, and compute the corresponding quantized fixed-point coefficients for each bin by following foregoing steps (2), (3), and (4). This allows optimization of the methods for memory and/or computational complexity instead of for precision performance. For example, a choice for an impulse response with energy concentrated in a neighborhood of a coefficient h(iₘₐₓ) could be three bins with the center bin containing h(iₘₐₓ) together with the neighboring 10% of the coefficients.

### 5. Further Preferred Embodiments

The preferred embodiment fixed-point representation methods can be applied to infinite impulse response (IIR) filter coefficients in addition to the illustrated FIR filter coefficients of section 2. Of course, IIR filters have other fixed-point effects, such as bit truncation, in addition to the filter coefficient quantization addressed by the preferred embodiment methods.

The preferred embodiment methods of foregoing section 3 extend in various ways while maintaining the feature of searching over a set of bins of the impulse response coefficients for efficient fixed-point representation. For example:

The number of bins, N+1, could also be varied; for example, searching over N=1, 2, 3, and 4 and then optimizing by comparing the total fixed-point quantization errors together with a weighting depending upon N to provide a trade-off of complexity and precision.

Limiting the sets of integers searched so that iₙ₊₁−iₙ is greater than some threshold, such as M/(10N) where M is the number of coefficients and N+1 is the number of bins. This simplifies the searching.

The starting set of numbers, h(0), h(1), . . . , h(M), could be any set of numbers and in either floating-point or fixed-point format with more than the target number of bits. And representations of negative numbers by other than twos complement and saturations with quantization could be used (and modify the inequalities noted).

What is claimed is:

1. A method for fixed-point representation of a set of numbers, comprising:
(a) provide a set of numbers h(0), h(1), . . . , h(M) where M is a positive integer;
(b) provide a first set of N integers, i₁, i₂, . . . , i_{N}, . . . , i_{N}, satisfying the following inequalities, 0<iᵢ<i₂<. . . <iₙ<. . . <i_{N}<M, where N is a positive integer smaller than M;
(c) for each n in the range n=0, 1, . . . , N, and taking i₀=0 and i_{N+1}=M, find the smallest integer Bn such that −2^{Bn}≦h(i)<2^{Bn} for all h(i) in the n^{th} bin defined as {h(iₙ), h(iₙ+1), . . . , h(iₙ₊₁−1)}, where Bn may be negative, zero, or positive;
(d) for each h(i) in said n^{th} bin, compute a corresponding quantized fixed-point coefficient ĥ(i) to precision based on said Bn from step (c);
(e) for each h(i) compute the fixed-point quantization error Δh(i)=h(i)−ĥ(i) where ĥ(i) is from step (d);
(f) compute a total fixed-point quantization error from the results of step (e);
(g) repeat steps (b)-(f) for at least a second set of N integers i₁, i₂, . . . , i_{N};
(h) select a representation set of N integers from the sets of N integers of steps (b) and/or (g) where said representation set of N integers minimizes the total fixed-point quantization errors found in steps (e)-(g), and use said representation set of N integers to define the fixed-point representations of the numbers.

2. The method of claim 1, wherein:
(a) said total fixed-point quantization error of step (f) of claim 1 is Σ_{0≦i≦M}|Δh(i)|.

3. The method of claim 1, wherein:
(a) said total fixed-point quantization error of step (f) of claim 1 is Σ_{0≦i≦M}|Δh(i)|².

4. The method of claim 1, wherein:
(a) said precision of step (d) is 2^{Bn-L+1} where L is the length of the fixed-point format (number of bits including the sign bit).

5. A method for fixed-point representation of a set of numbers, comprising:
(a) provide a set of numbers h(0), h(1), . . . , h(M) where M is a positive integer;
(b) provide a set of N integers, i₁, i₂, . . . , iₙ, . . . , i_{N}, satisfying the following inequalities 0<iᵢ<i₂<. . . <iₙ<. . . <i_{N}<M where N is a positive integer smaller than M;
(c) for each n in the range n=0, 1, . . . , N, and taking i₀=0 and i_{N+1}=M, find the smallest integer Bn such that −2^{Bn}≦h(i)<2^{Bn} for all h(i) in the n^{th} bin defined as {h(iₙ), h(i+1), . . . , h(iₙ₊₁−1)};
(d) for each h(i) in the n^{th} bin, compute a corresponding quantized fixed-point coefficient ĥ(i) to precision based on said Bn from step (c);
(e) represent each ĥ(i) from step (d) in a fixed-point format of length L where L is an integer greater than 2.

6. The method of claim 5, wherein:
(a) said precision of step (d) is 2^{Bn-L+1} where L is the length of the fixed-point format (number of bits including the sign bit).
